(19) United States
(12) Patent Application Publication
(10) Pub. No.: US 2006/0033292 A1
(43) Pub. Date: Feb. 16, 2006

(54) Apparatus and method for covering openings

(76) Inventors: Steven Martin Goldstein, Herald, CA (US); Robert Wayne VanZee, Fremont, CA (US); Louis Pace, San Carlos, CA (US)

Correspondence Address: RONALD ROHDE, 20 DESCANSO DRIVE, SUITE 1215, SAN JOSE, CA, 95134, US

(21) Appl. No.: 11/185,922

(22) Filed: Jul. 20, 2005

Related U.S. Application Data
(60) Provisional application No. 60/590,408, filed on Jul. 21, 2004.

(51) Int. Cl. F16J 15/02

(52) U.S. Cl. 277/640

(57) ABSTRACT

A method and apparatus to cover openings in a plurality of materials is described. In one embodiment, a disc shaped member includes a three-stepped surface having an outer, second, and inner surface, is configured to fit into and cover an existing opening. The outer surface is sized larger than the opening being covered. The second surface being sized to fit within such opening. The inner surface being the smallest and includes a blind hole for the insertion of a bolt. The bolt and an inner member cooperate such that the disk shaped member may be lined up with an inside surface of an opening of virtually any material or object configured to accept such a disk shaped member. Once the disk shaped member is fastened onto the exterior surface of a doorframe using a bolt and the inner member, for example, the existing hole being covered will no longer be visible or accessible, thereby beautifying, covering, and securing the object.

### CROSS-REFERENCE TO RELATED APPLICATIONS

This invention is based on U.S. Provisional Patent Application Serial No. 60/590,408 filed Jul. 21, 2004 entitled “APPARATUS AND METHOD FOR COVERING OPENINGS” filed in the name of Steven M. Goldstein, Robert Van Zee, and Louis Pace. The priority of this application is hereby claimed and it is hereby incorporated herein by reference thereto.

### BACKGROUND OF THE INVENTION

1. Field of the Invention

Embodiments of the present invention generally relate to devices used to cover openings in doors.

2. Description of the Related Art

Often, covers such as doors have openings such as holes therein used for locking devices. Such holes left uncovered may cause doors to look unfinished. Such holes left uncovered may also increase the risk of someone being able to open a door and therefore may pose a security issue. Often, locking devices are removed for legal reasons and for safety leaving the door unsecured. However, it is obviously a problem to leave a door that needs to be secure without a locking device. In some cases, a panic exit device is used to allow a door to be opened using a “panic bar” which allows the door to secured from the outside but opening from the inside. Unfortunately, many times such locking devices may interfere with panic exit devices and other devices associated with door security. Currently, apparatus are used to cover openings in doors to allow them to be secured from the outside but they often interfere with the operation and attachment of the panic devices and their location. Traditionally present art apparatus are unable to accomplish this because they are through bolted from one side of the hollow object to the other. Currently, through bolted hole fillers cannot be used because the screw/post connecting the inside disk to the outside disk will interfere with the concealed vertical rods inside the door. Thus, for beautification and security, one or more holes in doors, for example, need to be filled without obstructing internal parts of the door or objects.

Therefore, what is needed is a method and apparatus to cover holes in doors and other items. Further, what is needed is an apparatus and method to quickly and effectively cover existing cylinder, lock face and other unwanted holes/openings in any object made of any material which would benefit in terms of security or beautification, which is simpler in construction, more universally usable and more versatile in operation than known apparatus of this kind.

### SUMMARY OF THE INVENTION

An aspect of the present invention is an apparatus for covering an opening in a material. The apparatus includes a disk shaped outer member having a first disk member sized to cover at least a portion of the opening, and a second disk shaped member disposed adjacent the first disk shaped member. The second disk shaped member has a diameter sized smaller than a diameter of the first disk shaped member and is configured to fit within the opening. The apparatus further includes a third disk shaped member positioned adjacent the second disk shaped member. The third disk shaped member is sized to fit into an inner opening of the material. The third disk shaped member includes at least one longitudinal hole therein the longitudinal hole configured to accept one end of a bolt. The apparatus further includes an inner securing member sized such that at least two distal pressure points along a longitudinal axis thereof extend beyond the opening adjacent an opposite side of the material. The inner securing member includes an aperture. The aperture is sized to accept the bolt therethrough, but sized smaller than a head of the bolt. The inner securing member is configured to cooperate with the disk shaped outer member such that when secured by the bolt, the inner securing member and outer disk shaped member are drawn toward each other to clamp on an outside portion and an inside portion of the material to cover and seal the opening.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the present invention may admit to other equally effective embodiments.

FIG. 1 is an exploded perspective view of one embodiment of a disk device configured to cover openings in accordance with embodiments of the invention.

FIG. 2 is pictorial view of one embodiment of two or disk devices configured to cover openings in accordance with embodiments of the invention.

FIG. 3 is pictorial view of one embodiment of a disk device configured to cover openings in accordance with embodiments of the invention.

FIG. 4 is pictorial view of one embodiment of a disk device configured to cover openings in accordance with embodiments of the invention.

### DETAILED DESCRIPTION OF THE PREFERRED EMBODIMENT

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

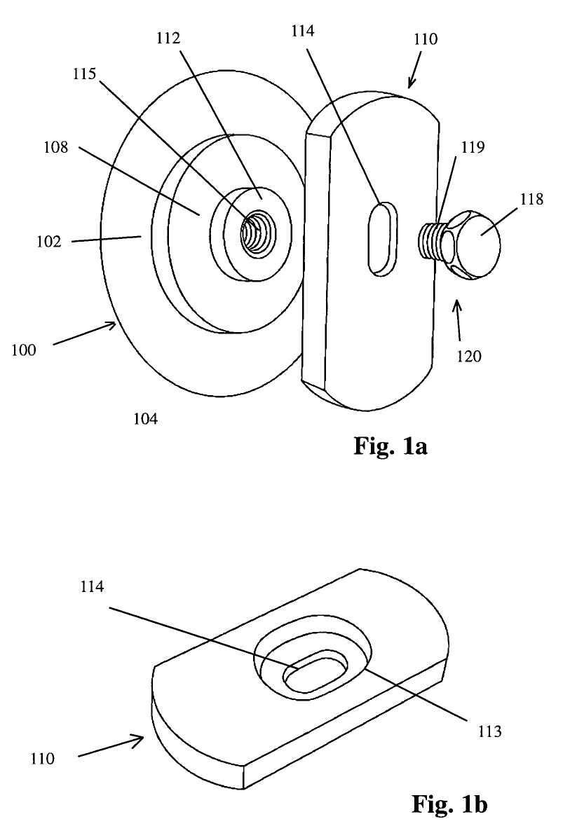

FIG. 1a is an exploded top perspective view of a disk device 100 configured to cover openings in accordance with embodiments of the invention. In one embodiment, disk device 100 is configured to cover holes in aluminum, wood, metal, glass, composite material doors, and the like. In one configuration, disk device 100 is a thin, flat disc with three step surfaces 104 defined by an outer disk member 102 and by inner disk members 108 and 112 disposed adjacent thereto. The inner disk member 112 having the smallest diameter relative the inner disk member 108 and outer disk member 102, and includes a blind hole 115 for the insertion of a bolt 120. Inner disk element 112 may be sized to fit into another opening of the material sized smaller than the opening being covered, such found in an opening profile for a lock, for example.

Bolt 120 includes a shank 119, and supports an inner member 110 configured such that the inner member 110 will line up on the surface on the inside of virtually any hole, e.g., opening, in virtually any object or material sized to accept such outer disk member 102. Inner member 110 includes a hole 114 to allow the shank 119 of the bolt 120 to pass therethough but not allow the head 118 to pass through hole 114. Inner member 110 is configured larger across a longitudinal axis to extend beyond an opening being covered as described below. Thus, when operated to secure apparatus 100 to a doorframe, bolt 120 may urge outer disk member 102 and inner member 110 toward one another as described below. Outer disk member 102 and inner member 110 may be formed of any material that may be used to advantage such as metal, plastic, wood, ceramics, and the like.

FIG. 1b is a bottom perspective view an alternative embodiment of the inner member 110 of FIG. 1a. Inner member 110 may include cavity 113. Cavity 113 may be sized to accept disk element 112.

In one operational embodiment, once the outer member 102 is positioned onto the exterior surface of the material, e.g., a frame of a door, to cover an adjacent opening, and then attached to the inner member 110 with bolt 120, such opening will no longer be visible or accessible, thereby beautifying, covering, and securing the object or material.

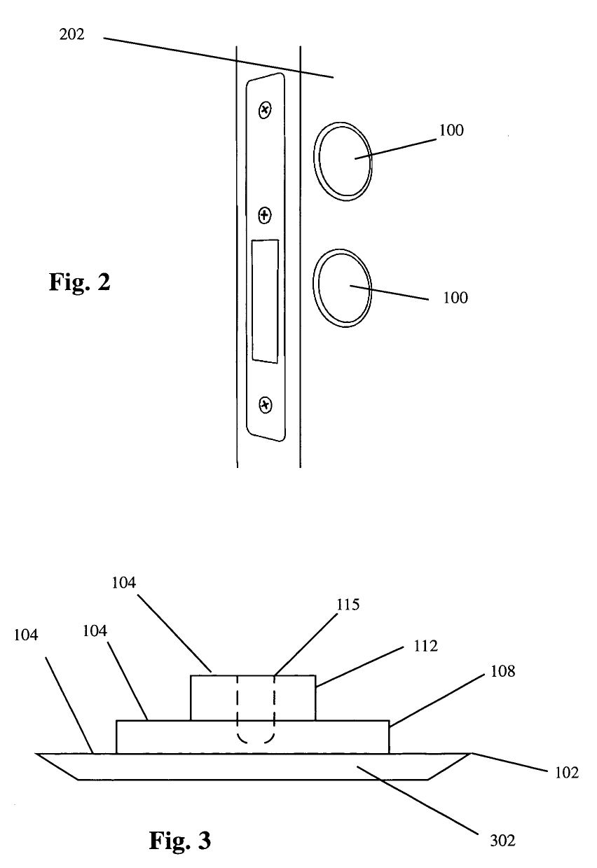

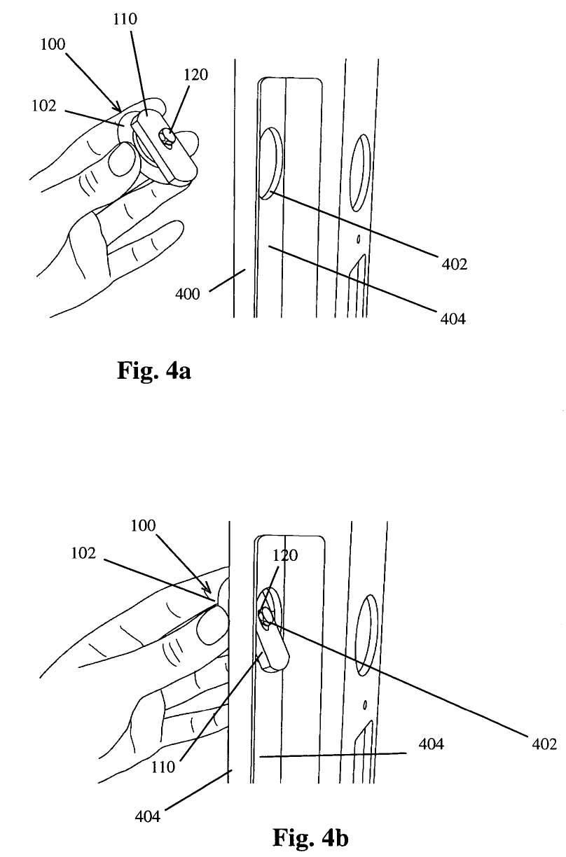

FIG. 2 is perspective view of one embodiment of two or more disk devices 100 configured to cover openings in accordance with embodiments of the invention. FIG. 3 is front elevation view of a disk device 100 configured to cover openings in accordance with embodiments of the invention. In one embodiment, disk device 100 is tapered on an outer edge 302 to be flush with an outer surface of a frame 202, such as a frame for a door or other article.

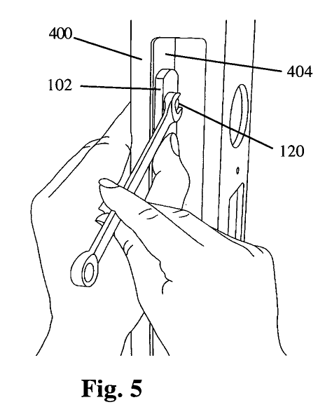

FIG. 4a is perspective view of one embodiment of a disk device 100 illustrating installation to cover openings 402 in accordance with embodiments of the invention. FIG. 4b is perspective view of one embodiment of a disk device 100 illustrating installation to cover openings 402 in accordance with embodiments of the invention. FIG. 5 is a perspective view of one embodiment of disk device 100 installed on a doorframe 400 in accordance with embodiments of the invention. Inner member 110 is illustrated in FIG. 5 secured to an inside portion of doorframe 400. Inner member 110 may be configured with a structure to extend across an opening 402 of doorframe 400 being covered by disk apparatus 100. As illustrated, bolt 120 is configured to adjoin and urge inner member 110 and outer disk member 102 toward each other to secure the disk device 100 to the doorframe 400. For example, inner member 110 may be formed generally rectangular in shape (as illustrated in FIGS. 1a and 1b) and may be sized to extend along a longitudinal axis across the opening 402 on inside surface of the doorframe 400. When bolt 120 is turned, as illustrated in FIG. 5, such to draw the inner member 110 and outer disk shaped member 102 together, at least two distal pressure points of the inner member 110 put force on the inside surface 404 while at least one of the inside surfaces of outer disk member 102 put opposing pressure on an outer surface of doorframe 400. In operation, the outer disk member 102 is sized with a diameter larger than the opening 402, and when clamped on doorframe 400, the inner member 110 and outer disk member 102 cover and secure opening 402.

While the foregoing is directed to embodiments of the present invention, other and further embodiments of the invention may be devised without departing from the basic scope thereof, and the scope thereof is determined by the claims that follow.

1. An apparatus for covering an opening in a material, the apparatus comprising:
a disk shaped outer member
having a first disk member
sized to cover at least a portion of the opening;
a second disk shaped member
disposed adjacent the first disk shaped member,
the second disk shaped member having a diameter sized smaller than a diameter of the first disk shaped member and
configured to fit within the opening;
a third disk shaped member
positioned adjacent the second disk shaped member,
the third disk shaped member being sized to fit into an inner opening of the
material,
the third disk shaped member including at least one longitudinal hole
therein
the longitudinal hole configured to accept one end of a bolt; and an inner securing member
sized such that at least two distal pressure points along a longitudinal axis thereof extend beyond the opening adjacent an opposite side of the material,
the inner securing member including an aperture, the aperture sized to accept the bolt therethrough, but sized smaller than a head of the bolt,
the inner securing member configured to cooperate with the disk shaped outer member such that when secured by the bolt, the inner securing member and outer disk shaped member are drawn toward each other to clamp on an outside portion and an inside portion of the material to cover and seal the opening.

2. The apparatus of claim 1, wherein:
the apperture in the inner securing member is elongated to accept a bolt at a predetermined position along the elongated aperture.

3. The apparatus of claim 1, wherein:
the first disk member is tapered on an outer edge to be flush with material adjacent the opening.

4. The apparatus of claim 1, wherein:
the first disk member is circular.

5. The apparatus of claim 1, wherein:
the first disk member is oval.

6. The apparatus of claim 1, wherein:
the first disk member is rectangular.

7. The apparatus of claim 1, wherein:
the first disk member is polyhedral.

8. The apparatus of claim 1, wherein:
the inner securing member includes a cavity proximate the third disk shaped member,
the cavity sized to accept the third disk shaped member.

9. The apparatus of claim 1, wherein:
the inner securing member is rectangular.

10. The apparatus of claim 1, wherein:
the inner securing member is triangular.

11. The apparatus of claim 1, wherein:
the inner securing member is oval.
